(19) United States
(12) Patent Application Publication
(10) Pub. No.: US 2025/0040472 A1
(43) Pub. Date: Feb. 6, 2025

(54) Active Depth Control Planting Mode

(71) Applicant: Motivo Engineering, LLC, Gardena, CA (US)

(72) Inventors: Alex Herpy, Long Beach, CA (US); Stephen Babin, Sagle, ID (US); Bryan Yaggi, Georgetown, TX (US); Allen Goad, Valencia, CA (US); Praveen Penmetsa, Newark, CA (US)

(21) Appl. No.: 18/714,870

(22) PCT Filed: Nov. 30, 2022
(86) PCT No.: PCT/US2022/080620

§ 371 Date: May 30, 2024

Related U.S. Application Data
(60) Provisional application No. 63/284,491, filed on Nov. 30, 2021.

(51) Int. Cl. A01C 11/02; A01C 7/20

(52) U.S. Cl. CPC A01C 11/02; A01C 7/203

(57) ABSTRACT

System and methods are provided for transplanting slips with an automated slip transplanter. The automated slip transplanter can comprise a planter unit to receive and plant slips, a conveyor belt operably coupled to the planter unit, and a controller. The conveyor belt can be configured to transfer the slips towards the planter unit, and the controller can be configured to control the planter unit and utilize one or more operational modes for planting a plurality of rows of slips. Each of the plurality of rows of slips can include evenly spaced slips in the ground.

### PRIORITY

This application claims the benefit of and priority to PCT Application No. PCT/US2022/080620 filed on Nov. 30, 2022 and U.S. Provisional application filed on Nov. 30, 2021 and having application Ser. No. 63/284,491, the entirety of said application being incorporated herein by reference.

### FIELD

Embodiments of the present disclosure generally relate to transplanting machines. More specifically, the embodiments of the disclosure relate to apparatuses, systems, and methods for an automated slip transplanter having one or more operational modes that may enable an active depth control planting mode and an active node control planting mode.

### BACKGROUND

As the increasing demand for produce continues to upsurge, agricultural industries drive to mitigate demand issues by bringing automation to many decades-old harvesting issues, such as increased labor scarcity, rising costs, etc. One example of these issues is faced with transplanters (e.g., slip transplanters), which generally require: (i) improved transplanting speeds and qualities, (ii) reduced labor expenses including reduced operator hours, and (iii) increased robustness and reliability for the lifetime of the transplanting machine. Furthermore, a typical transplanting season occurs over 10 weeks, requiring hundreds of laborers and operators to keep up with the pace of approximately 500,000 slips/hour during the limited windows of cooperative weather. To further complicate these issues, planting season typically occurs once a year—and it does not always occur as expected.

### SUMMARY

According to an aspect of the present disclosure, an automated slip transplanter is disclosed. The automated slip transplanter can include a planter unit configured to receive and plant slips, a conveyor belt operably coupled to the planter unit, and a controller configured to control the planter unit and utilize one or more operational modes for planting a plurality of rows of slips. The conveyor belt can be configured to transfer the slips towards the planter unit, and each of the plurality of rows of slips can include evenly spaced slips in the ground. In some embodiments, the controller can be further configured to implement the one or more operational modes to dynamically adjust a planting depth of the planter unit.

In an embodiment, the one or more operational modes can include an active depth control planting mode, an active node control planting mode, an active angle control planting mode, an active node counts control planting mode, and an active slip rate control planting mode.

In several embodiments, the planter unit can further include one or more sensors communicatively coupled to the controller, where the one or more sensors include a depth sensor, a motion sensor, a photoelectric sensor, an optical encoder, a rotary sensor, and a linear potentiometer sensor. The one or more sensors can be configured to measure one or more soil properties and collect one or more planting measurements in real-time as the planter unit traverses the ground of a field. The one or more planting measurements can include at least one or more of soil reflectance measurements, predetermined planting properties of the slips, and variable depth measurements between the ground and the planter unit.

In additional embodiments, the planter unit further includes a floating frame, and a singulation unit vertically disposed on the planter unit, the singulation unit having a plurality of automated grippers configured to singularly grasp slips from a plurality of cartridges. Further, the conveyor belt can include a belt with a plurality of brushed holders configured to receive the slips, and the controller can control the planter unit in real-time.

In some embodiments, the planter unit further includes a dirt flap, a sword, a furrow sword opener, and a closing wheels assembly, and the planter unit is supported by one or more closing wheels of the closing wheel assembly and the sword.

In an embodiment, the controller can dynamically adjust a planting depth of the sword assembly by actively controlling a depth of operation of the sword, the furrow sword opener, and the closing wheels.

In further embodiments, the one or more sensors can provide a signal to the controller based on at least an angle of rotation in relation to the ground and the planter unit.

According to another aspect of the present disclosure, a method for automated transplanting is disclosed. The method can include receiving plant slips by a planter unit; transferring the plant slips to the planter unit by a conveyor belt operably coupled to the planter unit; and controlling the planter unit by a controller by utilizing one or more operational modes for planting a plurality of rows of slips, where each of the plurality of rows of slips includes evenly spaced slips in the ground.

In an embodiment, the method for automated transplanting can further include implementing, by the controller, the one or more operational modes to dynamically adjust a planting depth of the planter unit. The one or more operational modes can include an active depth control planting mode, an active node control planting mode, an active angle control planting mode, an active node counts control planting mode, and an active slip rate control planting mode.

In several embodiments, the planter unit can include one or more sensors communicatively coupled to the controller, where the one or more sensors include a depth sensor, a motion sensor, a photoelectric sensor, an optical encoder, a rotary sensor, and a linear potentiometer sensor.

In some embodiments, the method further includes measuring and collecting, by the one or more sensors, one or more soil properties and one or more planting measurements in real-time as the planter unit traverses the ground of a field. The one or more planting measurements can include at least one or more of soil reflectance measurements, predetermined planting properties of the slips, and variable depth measurements between the ground and the planter unit.

In some embodiments, the method further can include dynamically adjusting a planting depth of a sword by actively controlling a depth of operation of the sword.

### BRIEF DESCRIPTION OF THE DRAWINGS

The above, and other, aspects, features, and advantages of several embodiments of the present disclosure will be more apparent from the following description as presented in conjunction with the following several figures of the drawings. The drawings refer to embodiments of the present disclosure in which:

FIG. 1 illustrates an isometric view of an exemplary embodiment of an automated slip transplanter, in accordance with an embodiment of the present disclosure;

FIGS. 2A-2B illustrate a series of cross-sectional views of a slip transplanted with an automated slip transplanter using an active depth control planting mode, in accordance with some embodiments of the present disclosure;

FIG. 3 illustrates a slip gripper of an automated slip transplanter, in accordance with some embodiments of the present disclosure;

FIG. 4 illustrate a block diagram of a method for automated slip planting in accordance with some embodiments of the present disclosure; and

FIG. 5 illustrates a block diagram of an exemplary data processing system, in accordance with embodiments of the disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as a “first operational mode,” may be made. However, the specific numeric reference should not be interpreted as a literal sequential order but rather interpreted that the “first operational mode” is different than a “second operational mode.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

For example, sweet potatoes have a unique lifecycle, one that has prohibited automation until recent developments. The main issue with the sweet potatoe involves the “slip” that is approximately one foot long, known as a highly variable plant stem harvested from the mother bed potatoes, and individually transplanted into the growing fields at the start of each season. Traditionally, only human hands have been capable of gently manipulating individual slips-without tearing their leaves and/or tangling multiple slip—and then inserting the individual slips into the ground.

In addition, typical planting depths for agricultural crops, such as sweet potato slips, may vary based on weather, topography, irregular harvesting season, and so on. Generally, one of the transplanter's objective is to place the slips into the well-drained, warm soil at a consistent depth to achieve uniform emergence. That is, germination and emergence may be optimized when the planting depth is controlled, consistent, and manually adjusted for planting in optimal soil properties. During, for example, maintenance operations of the transplanter, one or more adjustments of the actuator and other depth controlling components may be required to achieve the desired planting depth. Unfortunately, such adjustments to the transplanter are usually performed manually, and thus these manual adjustments are likely prone to human error and inconsistencies, which may then require more considerable resources, maintenance, and time.

Also, as noted above, moisture and temperature vary spatially within fields and within the top three inches of the soil due to soil texture, topography, geography, crop usage, irrigation patterns, residue cover, and a variety of other agricultural factors. As such, many growers and transplanters must occasionally compromise one factor for another, such as planting shallower/deeper into warmer/colder soil than desirable. Accordingly, there is a need for an automated transplanter capable of taking bulk stored harvested slips from a minimal operating crew and outputting a consistent planted row of evenly spaced transplanted slips to thereby improve various operational processes, such as labor costs, yield opportunities, and field utilization. In addition, there is a need for an automated transplanter capable of having multiple operational modes and actively controlling planting depths, angles, node counts, and slip rates to thereby achieve improved automation, increased production efficiency, and reduced high labor costs and operator hours.

Embodiments disclosed herein provide one or more apparatuses, systems, and methods for autonomously transplanting splits with an automated slip transplanter. Furthermore, several embodiments disclosed herein provide methods for actively controlling a depth planting mode of the automated slip transplanter to dynamically adjust a planting depth in real-time, and for actively controlling a node planting mode of the automated slip transplanter to dynamically target a predetermined number of nodes per slip for maximal plant yield implementation.

In most embodiments, the automated slip transplanter may comprise a planter unit, a singulation unit, a conveyor belt, and/or a controller. In some embodiments, the planter unit may be implemented as a floating frame assembly that includes a floating frame, a sword assembly, an open rail assembly, and a closing wheels assembly. For example, the planter unit may be supported by one or more wheels of the closing wheels assembly. In some embodiments, the singulation unit may include one or more singulation mechanisms, such as automated grippers configured to singularly grasp slips from multiple slip cartridges and discharge (or release) the singulated slips to the conveyor belt that is operably coupled to the singulation unit and planter unit. The conveyor belt may have a belt with brushed holders configured to receive the singulated slips and then to transfer (or convey) them consistently towards the planter unit. Furthermore, in many embodiments, the automated slip transplanter may use the controller to actively control the planter unit based on one or more operational modes (e.g., an active depth control planting mode, an active node control planting mode, etc.) for planting consistent rows of evenly spaced slips in the ground. As such, the controller may be configured to implement one or more of the operational modes to dynamically adjust (or vary) planting depths, planting angles, planting node counts, and/or planting slip rates.

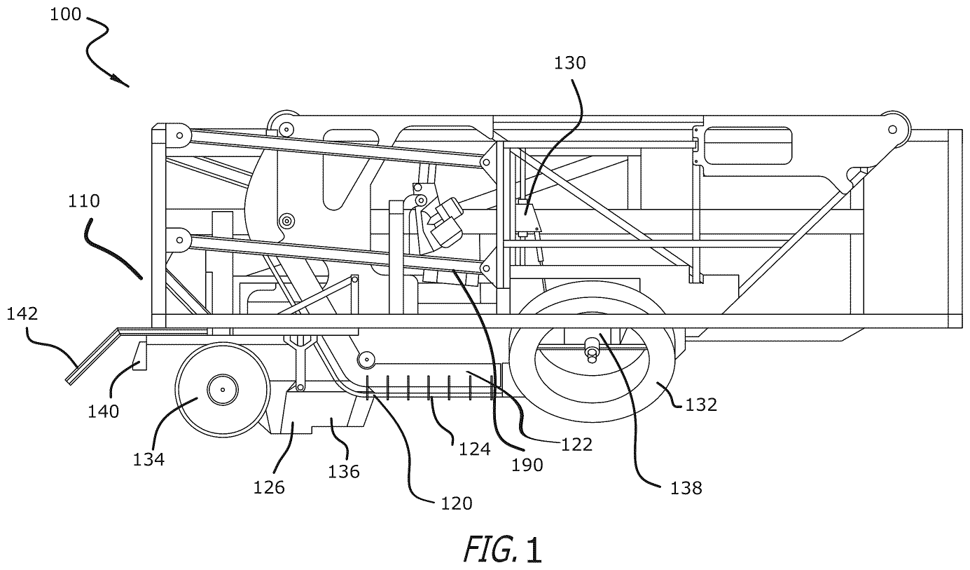

Referring to FIG. 1, an isometric view illustration of an automated slip transplanter 100 is shown, in accordance with embodiments of the disclosure. In these embodiments, as shown in FIG. 1, the automated slip transplanter 100 may include a planter unit 110 to receive and plant slips, a conveyor belt 120 operably coupled to the planter unit, and a controller 130 to control the planter unit and utilize one or more operational modes for planting a plurality of rows of slips. The conveyor belt can transfer the slips towards the planter unit. Further, each of the plurality of rows of slips can include evenly spaced slips in the ground.

In several embodiments, the automated slip transplanter 100 may be implemented as a slip transplanting system including, but not limited to, an articulator (e.g., a tractor) and the automated slip transplanter (hereinafter, may be referred to as the “transplanter”). In particular, the transplanter can be mounted to the articulator, where the articulator may be supported by one or more drive wheels. In an embodiment, the transplanter may have a hitch (or a first hitch) pivotally hitched to a hitch (or a second hitch) of the articular, where the hitches may be a point hitch, a tongue, and/or any similar hitching/towing mechanism. Additionally, in some embodiments, the articulator may tow the transplanter around a field and provide power to the transplanter (e.g., via a power take off (“PTO”)) for powering the operations of the transplanter).

As described herein, the embodiments of the automated slip transplanter 100 may be used for automated slip transplanting (or mostly/semi-automated transplanting), which may be implemented to: (i) actively manage a depth planting mode capable of dynamically adjusting a planting depth in real-time, (ii) actively manage a node planting mode capable of dynamically and autonomously targeting a predetermined number of nodes per slip, and/or (iii) actively control/manage a buffering mode capable of facilitating slip rejection and buffering input. As such, the automated slip transplanter 100 may thereby be used to substantially improve existing transplanting systems, machines, and/or processes by ensuring maximum field utilization, optimal per slip (or plant) yield implementation, and substantial cost-effective techniques, such that, for example, the labor costs and operator hours are significantly reduced.

Furthermore, in accordance with most embodiments, the automated slip transplanter 100 may be used to take bulk stored harvested slips from a minimal operating crew and output one or more consistent planted rows of evenly spaced transplanted slips. For example, the automated slip transplanter 100 may be configured to plant any desired number of rows including, but not limited to, one row, two rows, four rows, and/or eight rows. Furthermore, in accordance with several other embodiments, the automated slip transplanter 100 may be configured to autonomously carry out one or more operational modes in real-time to actively control and adjust a planting depth, a planting angle, a targeted node count, a planting slip rate, and/or any other desired transplanting configuration. That is, in several embodiments, the operational modes implemented by the automated slip transplanter 100 may include, but are not limited to, an active depth control planting mode, an active node control planting mode, a slip rejection/buffering mode, and so on.

As illustrated in FIG. 1, the controller 130 of the automated slip transplanter 100 can implement the one or more operational modes to dynamically adjust a planting depth of the planter unit. In some embodiments, the one or more operational modes can include an active depth control planting mode, an active node control planting mode, an active angle control planting mode, an active node counts control planting mode, and an active slip rate control planting mode. That is, the controller 130 can actively control the depth at which the slips are planted, to ensure that the slips are planted at the same depth and therefore, the plantation is performed uniformly. Further, the controller 130 can control the number of nodes per slip being planted, so the node number is kept fixed and/or the node number is changed in response to a change in the condition of the plantation/request by the user. Further, the controller 130 can control the angle at which the slips are planted to take into account the change in the slope of the soil. As an example, where the ground is sloped (e.g., on the hills or in bumpy fields), the controller 130 can change the angle of plantation accordingly to maintain a uniform planation and/or to take into account the effect of the angle on the irrigation of the plants. Even further, the controller 130 can control the number of slips being planted at a given distance to maintain the density at which the slips are planted.

In several embodiments, the automated slip transplanter 100 may further include a singulation unit/assembly 190. The singulation unit 190 can be vertically disposed on the planter unit 110, and include a plurality of automated grippers to singularly grasp slips from a plurality of cartridges. It should be understood that, although FIG. 1 depicts one specific view, illustration, and assembled configuration of the various components and subassemblies of the automated slip transplanter 100, it is appreciated that more or less mechanisms may be used, that one or more mechanisms may be positioned differently (or in different locations), that one or more assemblies/sub-assemblies may be assembled differently and using more or less mechanisms, and that one or more mechanism, assemblies, and/or sub-assemblies may be assembled using different techniques, sizes, etc., without limitations.

The automated slip transplanter 100 may have the singulation unit 190 operably coupled to the planter unit 110, where the singulation unit 190 may be disposed on or over the planter unit 110. In some embodiments, the singulation unit 190 may include one or more singulation mechanisms, such as automated grippers (or robotic arms, fingers, etc.) configured to singularly grasp slips from multiple slip cartridges and discharge/release them onto the conveyor belt 120. Furthermore, the conveyor belt 120 may be operably coupled to the singulation unit 190 and the planter unit 110. For example, the conveyor belt 120 may have a continuous belt 122 with multiple hinged brushed slip holders 124, where the brushed slip holders 124 may be configured to receive the singulated slips and then transfer/convey them down towards the planter unit 110.

In order to actively control the plantation condition, the planter unit 110 can include one or more sensors 140 communicatively coupled to the controller 130. The one or more sensors 140 can include a depth sensor, a motion sensor, a photoelectric sensor, an optical encoder, a rotary sensor, and a linear potentiometer sensor. The one or more sensors 140 can measure one or more soil properties and collect one or more planting measurements in real-time as the planter unit 110 traverses the ground of a field. The one or more planting measurements can include at least one or more of soil reflectance measurements, predetermined planting properties of the slips, and variable depth measurements between the ground and the planter unit 110.

Furthermore, the automated slip transplanter 100 may use the planter unit 110 to receive the bulk stored harvested slips from a minimal operating crew (if desired), and then autonomously output a consistent planted row of evenly spaced transplanted slips. In several embodiments, as discussed above, the planter unit 110 may be managed/controlled with the controller 130, which may operate in conjunction with the one or more sensors 140. That is, the automated slip transplanter 100 may use the controller 130 to actively control the planter unit 110 based on one or more operational modes such as an active depth control planting mode, an active node control planting mode, and so on.

For example, the controller 130 in conjunction with the one or more sensors 140 may be configured to implement one or more of the operational modes to dynamically adjust planting depths, planting angles, planting node counts, and/or planting slip rates. In some embodiments, the one or more sensors 140 may be arranged directly in front of the sword 142 and disposed between the dirt flap 132 and the sword 142. As such, this configuration may facilitate the active depth control planting mode for the automated slip transplanter 100, which may then be used to dynamically adjust the planting depth of the planting unit 110 in real-time, such that the sword 142, the furrow sword opener 136, and/or the closing wheels 132 may be dynamically adjusted higher and/or lower into the soil with respect to the z-axis. For example, the one or more sensors 140 may be configured to provide a signal to the controller 130 based on at least an angle of rotation in relation to the ground and the planter unit 110. In another example, the controller 130 may be configured to implement the active depth control planning mode to dynamically adjust the planting depth based on one or more planting measurements (or data points) collected by the one or more sensors 140. Furthermore, the controller 130 may be configured to actively adjust a depth of operation of the planter unit 110 based on any of the planting measurements collected by the one or more sensors 140, where the depth of operation may include adjusting all (or most) of the mechanisms of the planter unit 110 in order to achieve a newly desired planting depth/angle.

In some embodiments, the one or more sensors 140 may include, but is not limited to, a depth sensor, a motion sensor, a photoelectric sensor, an optical encoder, a rotary sensor, a linear potentiometer sensor, and/or any other similar depth sensing device. Furthermore, as described above, the one or more sensors 140 may be configured to measure one or more soil properties and collect one or more planting measurements in real-time as the planter unit 110 traverses the ground/field. For example, the one or more sensors 140 may be configured to collect the measurement data with regard to the soil properties and/or the collected planting measurements, where the collected planting measurements may further include, but are not limited to, soil reflectance measurements, predetermined planting properties of the transplanted slips, and/or variable depth measurements between the ground and the planter unit 110 (or between the ground and any components of the automated slip transplanter 100). Continuing with the illustration of FIG. 1, the planter unit 110 may be configured as a floating frame assembly that includes, but is not limited to a floating frame 120, a closing wheels assembly 138, and a sword assembly 132.

In an embodiment, a side rail frame may surround/house the floating frame 126 and be pivotally coupled to and supported (or maneuvered) by the closing wheels 132 of the closing wheels assembly 138. According to several embodiments, the side rail frame may be coupled to the floating frame 126 via a four-bar mount plate, two upper linkage bars, and two lower linkage bars. In some embodiments, the side rail frame may be configured with a platform, an opening 113 for the platform, and a pair of handles, where the platform may support an operator (if desired) and/or store bulk harvested slips, slip cartridges, and so on. For example, the side rail frame, the floating frame 126, and any other frames of the automated slip transplanter 100 may be composed of a metallic material (e.g., aluminum, titanium, or stainless steel, brass, copper, chromoly steel, iron, and/or the like), a composite material (e.g., carbon fiber), a polymeric material (e.g., plastic), and/or some combination of these materials (or any other similar materials). That is, the frames of the automated slip transplanter 100 may need to be formed with a substantially rigid material that may support stress applied at/near any of the frame's joints/nodes, and also support compression, tension, torsion, shear stresses, and/or some type of combination of these stress types.

In addition, the planter unit 110 may be configured with a sword assembly comprising of, but not limited to, a furrow sword opener 136, a sword 142 (or sword disk, furrow disk, etc.), a dirt flap 144, and the one or more sensors 140. As shown, in several embodiments, the planter unit 110 may be supported by one or more wheels 132 of the closing wheels assembly 138 and/or the sword 142 of the sword assembly. In some embodiments, the controller 103 can dynamically adjust a planting depth of the sword assembly by actively controlling a depth of operation of the sword 142, the furrow sword opener 136, and the closing wheels 132.

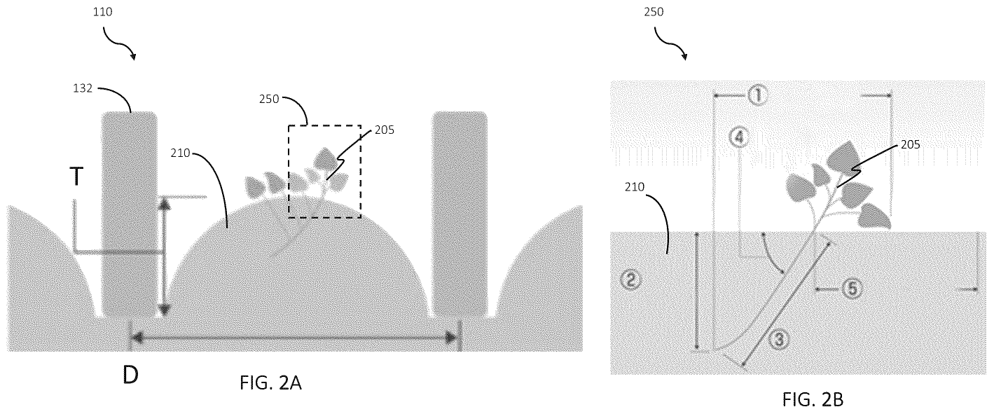

Referring now to FIGS. 2A-2B, a series of cross-sectional view illustrations of a slip 205 transplanted with the planter unit 110 are shown, in accordance with embodiments of the disclosure. It should be understood that the planter unit 110 depicted in FIG. 2A may be substantially similar to the planter unit 110 depicted above in FIG. 1. As shown in FIG. 2A, the planting unit 110 may utilize the closing wheels 132 to output the transplanted slip 250 planted within the soil (or ground) 210. Also, as illustrated in FIG. 2A, when/if the active depth control planting mode is implemented, one or more planting measurements may be measured/collected in order to actively adjust the planting depth that may have been used to output the transplanted slip 250. For example, the planting measurements may include: (i) a distance between the closing wheels 132 (as depicted with “D”), and (ii) a depth (or thickness) of the soil 210 (as depicted with “T”), which may also be measured with the distance between the top level of the soil 210 and the bottommost level of the closing wheels 132.

Similarly, as shown in greater detail in FIG. 2B, other planting measurements may be collected when the slip 205 was planted into the soil 210 (as depicted with circle “1” through circle “5”). Furthermore, as noted, the planter unit 110 may be capable of diagonal (or angled/tilted) planting which may limit the number of potatoes but promotes hypertrophy and enables harvesting in a short time. In some embodiments, the planter unit 110 may also be configured to plant any desired length of slips 205 (i.e., from short to long slips 205). For example, the planting depth (or insertion length) of the slip 205 may be easily adjusted by the planter unit 110 by the one or more operational modes discussed above. In addition, the planter unit 110 may be used for reliable planting that allows stable insertion lengths of the slips 205. Furthermore, as discussed above, the planter unit 110 may be configured for automated and dynamic depth tracking by implementing the one or more sensors 140 and/or controller 140 depicted in FIG. 1. For example, prior to planting the slip 205, the planting unit 110 may have automatically detected the depth (or height) of the ridge in the soil 210, such that the wheels 132 (and/or any other predetermined mechanisms of the planter unit 110, including the sword 134 and furrow sword opener 136 of FIG. 1) may have been controlled automatically to move up and down based on any detected depth level difference.

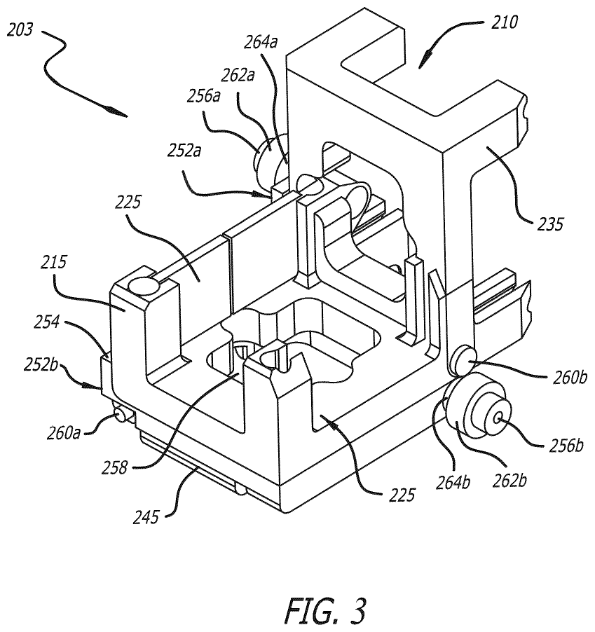

Referring now to FIG. 3, a schematic view of a slip holder 203 of an automated slip transplanter, in accordance with embodiments of the disclosure is shown. In some embodiments, each slip holder 203 may include, but is not limited to, a slip bristle holder 215 (or a bristle holder hinged), a plurality of bristle sections 225, a belt slip holder 235, a belt holder base 245, and an intermediate double-sided hinge 254, where each of these components/mechanisms are coupled together and are operably coupled to the conveyor belt. That is, the individual slip holder 203 may be implemented with the slip bristle holder 215, the bristle sections 225, and the belt slip holder 235 that are coupled together by the belt holder base 245 and the intermediate double-sided hinge 254. Furthermore, the individual slip holder 203 may also include, but is not limited to, torsion springs 252a-b, shoulder screws 256a-b, screws 258, ball bearing rings 262a-b, spacers 264a-b, and hinge pins 260a-b. Further, in some embodiments, the slip holder 203 may include a plurality of slips, a continuous belt, a top body frame/chassis, a plurality of automated grippers (or claws, robotic arms, gantry assemblies, etc.), a controller, and a plurality of slip cartridges that are used to store the slips. In some embodiments, the conveyor belt may include a continuous belt coupled (or hinged) to each of the plurality of slip holders 203, where each slip holder 203 may receive (or collect/singulate) one slip and then consistently transfer the slips towards a first end of the lower belt portion for plantation.

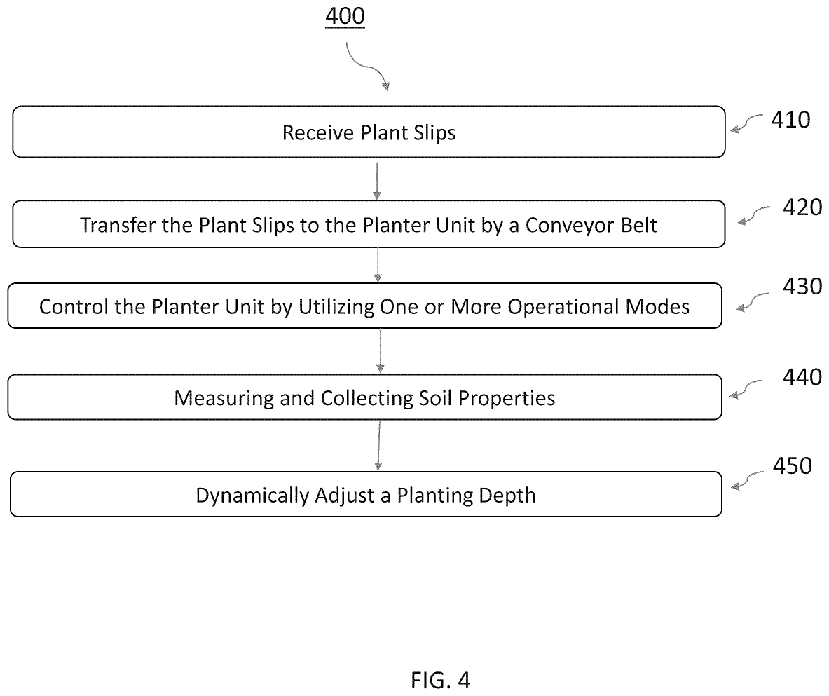

Referring now to FIG. 4, a block diagram of a method for automated slip planting 400 in accordance with some embodiments of the disclosure is shown. As shown by block 410, the method for automated slip planting 400 starts when the method 400 receives plant slips. The method 400 then can transfer the plant slips to the planter unit via a conveyor belt, as shown by block 420. The method 400 proceeds when the method 400 utilizes one or more operational modes to control the planter unit, as shown by block 430. As shown by block 440, the method 400 then measures and collects soil properties. As noted above, one or more sensors can be utilized to collect and measure the soil properties. Finally, and as shown by block 450, the method 400 continues to dynamically adjust a planting depth at which the plant slips are being planted.

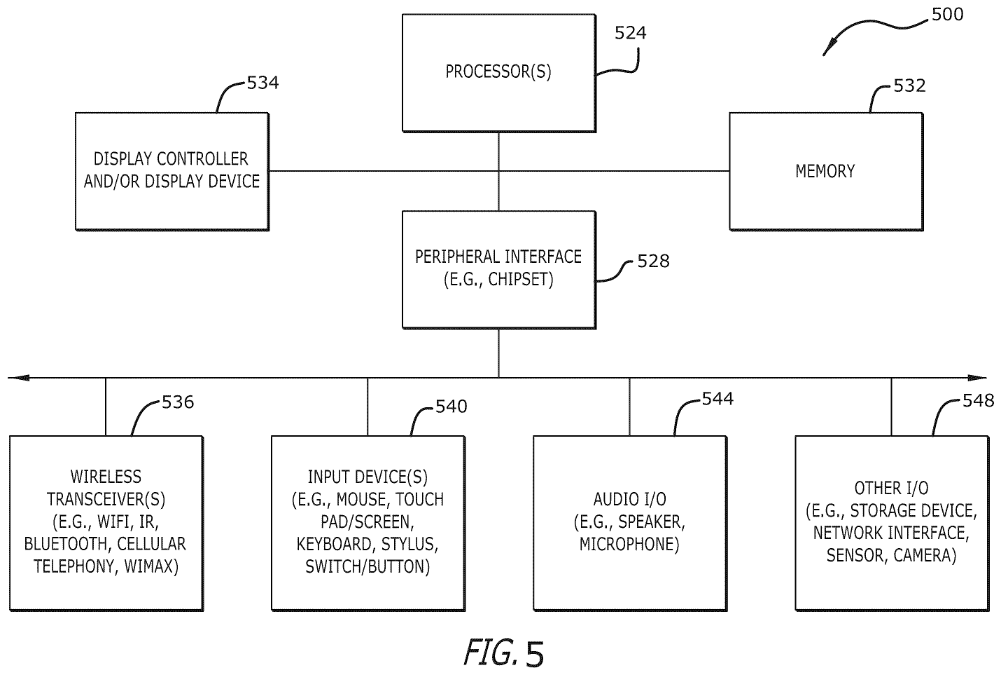

Referring now to FIG. 5, a block diagram of an exemplary data processing system 500 is shown, in accordance with embodiments of the disclosure. In some embodiments, the data processing system 500 may be implemented with the automated slip transplanter 100 depicted in FIG. 1. As discussed above, the automated slip transplanter 100 may include one or more electronic components, modules, controllers, and/or any other similar data processing devices. In accordance with several embodiments, the automated slip transplanter 100 may house a variety of electronic devices, components, and/or circuitry, such as one or more processors, memory devices, and/or the like that may be configured to run software applications suitable for operating the automated slip transplanter 100 (e.g., the active depth controller 130, the sensor 140, the electrical controls and lines, the main controller, etc.).

To this end, the exemplary embodiments of the data processing system 500 may be used in conjunction with the automated slip transplanter 100 to perform any of the processes or methods described herein. The data processing system 500 may represent circuitry associated with the one or more electrical controllers (or devices) of the automated slip transplanter 100, a desktop, a tablet, a server, a mobile phone, a personal digital assistant (PDA), a personal communicator, a network router or hub, a wireless access point (AP), a repeater, a set-top box, and/or any combination thereof. In an embodiment, the data processing system 500 may include one or more processor(s) 524 and a peripheral interface 528, also referred to herein as a chipset, to couple various components to the processor(s) 524, including a memory 532 and devices 536-548 via a bus or an interconnect. Processor(s) 524 may represent a single processor or multiple processors with a single processor core or multiple processor cores included therein. Processor(s) 524 may represent one or more general-purpose processors such as a microprocessor, a central processing unit (CPU), or the like.

More particularly, the processor(s) 524 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processor(s) may also be one or more special-purpose processors such as an application specific integrated circuit (ASIC), a field programmable gate array (FPGA), a digital signal processor (DSP), a network processor, a graphics processor, a network processor, a communications processor, a cryptographic processor, a co-processor, an embedded processor, or any other type of logic capable of processing instructions. The processor(s) may be configured to execute instructions for performing the operations and steps discussed herein.

In several embodiments, the peripheral interface 528 may include a memory control hub (MCH) and an input output control hub (ICH). The peripheral interface 528 may include a memory controller (not shown) that communicates with a memory 532. The peripheral interface 528 may also include a graphics interface that communicates with graphics subsystem 534, which may include a display controller and/or a display device. The peripheral interface 528 may communicate with the graphics device 534 by way of an accelerated graphics port (AGP), a peripheral component interconnect (PCI) express bus, or any other type of interconnects.

An MCH may generally be referred to as a Northbridge, and similarly an ICH may generally be referred to as a Southbridge. As used herein, the terms MCH, ICH, Northbridge and Southbridge are intended to be interpreted broadly to cover various chips that perform functions including passing interrupt signals toward a processor. In some embodiments, the MCH may be integrated with the processor 524. In such a configuration, the peripheral interface 528 operates as an interface chip performing some functions of the MCH and ICH. Furthermore, a graphics accelerator may be integrated within the MCH or the processor (524).

In most embodiments, the memory 532 may include one or more volatile storage (or memory) devices, such as random access memory (RAM), dynamic RAM (DRAM), synchronous DRAM (SDRAM), static RAM (SRAM), and/or any other similar types of storage devices. The memory 532 may store information including sequences of instructions that are executed by the processor 524, and/or any other device. For example, executable code and/or data of a variety of operating systems, device drivers, firmware (e.g., input output basic system or BIOS), and/or applications can be loaded in the memory 532 and executed by the one or more processors 524. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

In many embodiments, the peripheral interface 528 may provide an interface to IO devices, such as the devices 536-548, including wireless transceiver(s) 536, input device(s) 540, audio IO device(s) 544, and other IO devices 548. The wireless transceiver 536 may be a WiFi transceiver, an infrared transceiver, a Bluetooth transceiver, a WiMax transceiver, a wireless cellular telephony transceiver, a satellite transceiver (e.g., a global positioning system (GPS) transceiver) or a combination thereof. The input device(s) 540 may include a mouse, a touch pad, a touch sensitive screen (e.g., such screen may be integrated with the display device 534), a pointer device such as a stylus, and/or a keyboard (e.g., physical keyboard or a virtual keyboard displayed as part of a touch sensitive screen). For example, the input device 540 may include a touch screen controller coupled with a touch screen. The touch screen and touch screen controller may, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

In several embodiments, the audio IO 544 may include a speaker and/or a microphone to facilitate voice-enabled functions, such as voice recognition, voice replication, digital recording, and/or telephony functions. Other optional devices 548 may include a storage device (e.g., a hard drive, a flash memory device), universal serial bus (USB) port(s), parallel port(s), serial port(s), a printer, a network interface, a bus bridge (e.g., a PCI-PCI bridge), sensor(s) (e.g., a motion sensor, a light sensor, a proximity sensor, etc.), and/or a combination thereof. These optional devices 548 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips.

Although one or more specified components of the data processing system 500 are depicted in FIG. 5, it should be understood that they are not intended to represent any particular architecture and/or manner of interconnecting any of those components, as such details are not germane to embodiments of the present disclosure. It should also be appreciated that network computers, handheld computers, mobile phones, and/or other data processing systems, which have fewer components or perhaps more components, may also be used with embodiments of the invention disclosed hereinabove.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it should be appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The techniques shown in the figures can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals-such as carrier waves, infrared signals, digital signals).

The processes or methods depicted in the preceding figures may be performed by processing logic that comprises hardware (e.g., circuitry, dedicated logic, etc.), firmware, software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

1. An automated slip transplanter 100, comprising:
a planter unit 110 configured to receive and plant slips;
a conveyor belt 120 operably coupled to the planter unit, wherein the conveyor belt is configured to transfer the slips towards the planter unit; and
a controller 130 configured to control the planter unit and utilize one or more operational modes for planting a plurality of rows of slips, wherein each of the plurality of rows of slips includes evenly spaced slips in the ground.

2. The automated slip transplanter of claim 1, wherein the controller is further configured to implement the one or more operational modes to dynamically adjust a planting depth of the planter unit.

3. The automated slip transplanter of claim 1, wherein the one or more operational modes include an active depth control planting mode, an active node control planting mode, an active angle control planting mode, an active node counts control planting mode, and an active slip rate control planting mode.

4. The automated slip transplanter of claim 1, wherein the planter unit further includes one or more sensors communicatively coupled to the controller, wherein the one or more sensors include a depth sensor, a motion sensor, a photoelectric sensor, an optical encoder, a rotary sensor, and a linear potentiometer sensor.

5. The automated slip transplanter of claim 4, wherein the one or more sensors are configured to measure one or more soil properties and collect one or more planting measurements in real-time as the planter unit traverses the ground of a field.

6. The automated slip transplanter of claim 5, wherein the one or more planting measurements comprise at least one or more of soil reflectance measurements, predetermined planting properties of the slips, and variable depth measurements between the ground and the planter unit.

7. The automated slip transplanter of claim 1, wherein the planter unit further includes a floating frame.

8. The automated slip transplanter of claim 1, further comprising:
a singulation unit vertically disposed on the planter unit, the singulation unit having a plurality of automated grippers configured to singularly grasp slips from a plurality of cartridges.

9. The automated slip transplanter of claim 1, wherein the conveyor belt comprises a belt with a plurality of brushed holders configured to receive the slips.

10. The automated slip transplanter of claim 1, wherein the controller is configured to control the planter unit in real-time.

11. The automated slip transplanter of claim 1, wherein the planter unit further includes a dirt flap, a sword, a furrow sword opener, and a closing wheels assembly, and wherein the planter unit is supported by one or more closing wheels of the closing wheel assembly and the sword.

12. The automated slip transplanter of claim 11, wherein the controller is further configured to dynamically adjust a planting depth of the sword assembly by actively controlling a depth of operation of the sword, the furrow sword opener, and the closing wheels.

13. The automated slip transplanter of claim 4, wherein the one or more sensors are configured to provide a signal to the controller based on at least an angle of rotation in relation to the ground and the planter unit.

14. A method for automated transplanting, comprising:
receiving plant slips by a planter unit 110;
transferring the plant slips to the planter unit by a conveyor belt 120 operably coupled to the planter unit; and
controlling the planter unit by a controller 130 by utilizing one or more operational modes for planting a plurality of rows of slips, wherein each of the plurality of rows of slips includes evenly spaced slips in the ground.

15. The method for automated transplanting of claim 14, further comprising:
implementing, by the controller, the one or more operational modes to dynamically adjust a planting depth of the planter unit.

16. The method for automated transplanting of claim 14, wherein the one or more operational modes include an active depth control planting mode, an active node control planting mode, an active angle control planting mode, an active node counts control planting mode, and an active slip rate control planting mode.

17. The method for automated transplanting of claim 14, wherein the planter unit includes one or more sensors communicatively coupled to the controller, wherein the one or more sensors include a depth sensor, a motion sensor, a photoelectric sensor, an optical encoder, a rotary sensor, and a linear potentiometer sensor.

18. The method for transplanting of claim 17, further comprising:
measuring and collecting, by the one or more sensors, one or more soil properties and one or more planting measurements in real-time as the planter unit traverses the ground of a field.

19. The method of transplanting of claim 18, wherein the one or more planting measurements comprise at least one or more of soil reflectance measurements, predetermined planting properties of the slips, and variable depth measurements between the ground and the planter unit.

20. The method of transplanting of claim 14, further comprising:
dynamically adjusting a planting depth of a sword by actively controlling a depth of operation of the sword.
